(19) United States
(12) Patent Application Publication
(10) Pub. No.: US 2026/0133334 A1
(43) Pub. Date: May 14, 2026

(54) WATER BOTTOM SENSOR DEPLOYMENT FOR HIGH RESOLUTION SEISMIC SURVEYS

(71) Applicant: EPLSolutions LLC, Tiverton, RI (US)

(72) Inventors: David Wilson, Tiverton, RI (US); Brandon Mattox, Richmond, TX (US); David Monk, Houston, TX (US); David Ridyard, Novato, CA (US)

(21) Appl. No.: 18/945,517

(22) Filed: Nov. 13, 2024

Related U.S. Application Data
(60) Provisional application No. 63/598,154, filed on Nov. 13, 2023.

(51) Int. Cl. G01V 1/38

(52) U.S. Cl. CPC G01V 1/3808; G01V 1/3852

(57) ABSTRACT

A method includes deploying a plurality of seismic sensors onto the bottom of a body of water. The deploying includes moving at least one sensor frame having seismic sensors disposed therein in fixed positions to the bottom. A vessel is moved on a surface of the body of water proximate a location of the seismic sensors on the bottom. The vessel has mounted thereon a plurality of seismic sources at fixed positions in a direction transverse to a direction of motion of the e vessel. The sources are suspended from the vessel in the water. At selected times, the sources are actuated. Seismic energy is detected at the plurality of seismic sensors in response to energy emitted by the sources interacting with formations below the bottom of the body of water.

### CROSS REFERENCE TO RELATED APPLICATIONS

Priority is claimed from U.S. Provisional Application No. 63/598,154 filed on Nov. 13, 2023.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of seismic surveying of formations below the bottom of a body of water. More particularly the present disclosure relates to apparatus and methods for deploying seismic sensors on the bottom of a body of water for high resolution surveying of sediments and formations below the water bottom.

Placement of structures in a body of water such as a lake or the ocean requires an accurate understanding of the shallow subsurface below the water bottom (sea floor) to ensure that there are no problems when structures such as monopiles are pushed through the sea floor to deploy supported structures above the water. A non-limiting example of such structures includes wind turbines to drive electric generators. Surveys for such purposes, such as reflection seismic surveys, require a high-resolution image including in depth the first few tens of meters in the sediments and formations below the water bottom, but having accuracy of a few centimeters. Such seismic surveying requires high frequency sources and high frequency receivers, and recording seismic signals with very dense subsurface spatial sampling.

Where a typical seismic survey for oil and gas exploration purposes may use seismic energy frequencies up to approximately 100 Hz, the requirements for offshore structural placement may require seismic energy frequencies up to several kHz. It is not uncommon to scale the relative requirements by a factor of 50. There are several direct objectives of these surveys.

What is also desirable for purposes of placement of structures into sediments and formations below the water bottom includes quantitative determination of water bottom sediment and formation properties. Such determination can lead to improved confidence in soil properties at and surrounding the structure placement location, and offers the potential to optimize structure foundation design, optimize micro-siting opportunities and reduce the amount of foundation required.

Identification of hard obstacles in the subsurface sediments (e.g., boulders, hard ground and cemented sediment layers) prior to placement of a structure can avoid damage while the structures (e.g., piles) are driven into the subsurface. Pile rejection and damage can result in delays and additional costs to a project. Additionally, if the site of the structure has to be moved on discovery of such obstacles during structure installation, then it may be necessary to re-design ancillary structures, e.g., the cables connecting a wind farm to a remote electrical load which results in additional delay and cost.

Further, to avoid structural damage and to optimize pile placement during the design of the water bottom supported structure, identification of geohazards, e.g., variable permeable earthen formations, can result in delay avoidance in the project's final design and permitting, and can reduce risk to the structural integrity of the foundation. This can also cause delays to piling and pile refusal, i.e., the pile being unable to reach target depth and therefore unusable pile location. Likewise, soft sediments can cause pile-run, an equally serious issue in construction.

Finally, a high-resolution 3D seismic survey may reduce or eliminate the need to acquire additional geotechnical data, such as borehole or CPT (cone penetrometer) information.

High resolution seismic surveys for sub-bottom imaging known in the art may use a high-resolution source actuated rapidly, and a large deployment of short sensor cables (streamers) towed behind a single survey vessel. Seismic sources used in such surveys can be sparkers, boomers, or in some cases small air guns. Streamers typically sample reflected seismic energy using a short array of hydrophones in streamers which may each be 50 m long. A typical geometry is shown in FIG. 1. Note that in the arrangement of FIG. 1 there are a small number of sources and a large number of sensors. While the theoretical configuration shown in FIG. 1 provides consistent and equal spacing between the sources and sensors, in practice the sources and sensors will deviate from equal spacing, and the relative positions of the sources and sensors with respect to each other will vary as the system is towed through the water resulting in uncertainty of their position.

It is typical to activate the source rapidly (3 times a second, for example with a vessel speed of approximately 5 knots) since the sediment and formations of interest are typically only 50 to 100 m below the water bottom and may be located in relatively shallow water depths (up to around 50 m). While the source position can be known with accuracy by using a geodetic position sensor (e.g., GPS or GNSS satellite signal receiver) on a float above the source, the same is not possible for the seismic sensors since they are not connected directly to such a position sensor, and seismic sensor location therefore relies on a network of acoustic measurements and geomagnetic direction sensors (compasses) in the system. Additionally, the geodetic position of the sensors is constantly moving in a towed streamer survey, and the streamers are subject to currents and waves which move them relative to the towing vessel (and vertically with respect to the sea surface). While positioning to within a few meters is usually adequate for deep seismic work associated with typical hydrocarbon exploration, the requirements for imaging of the shallow subsurface to the accuracy required for very high resolution shallow imaging below the sea floor may be impractical using a towed streamer seismic survey system. Movement of the streamers transverse to the direction of vessel motion (in the crossline direction), called cable feather, also means that the coverage (area of illumination) may not be where it is intended, and multiple passes of the vessel may be required to fully image a particular subsurface area. Multiple passes may also be required to obtain the imaging of the desired coverage since a single vessel pass will typically not result in a wide enough illumination area.

Additionally, the seismic sensors in the streamers may each be composed of a set of hydrophones connected in series to attenuate certain types of noise. Such arrangement has a finite length rather than acting as a point receiver. As a practical matter, this results in a smear of the resultant image, since acoustic energy arrives at each receiver at a slightly different time, unless a plane wave arrives at exactly the same time to all receivers. The attenuation of seismic signals due to arrivals at different times into receivers which are within a single array can be computed for a Gaussian distribution of times, and such attenuation is much more significant at higher frequencies:

$${F}_{( - NdB )} = \frac{\sqrt{N}}{13.08 δ} \qquad ( 1 )$$

where: F is the frequency at which the signal is N dB down and δ is the standard deviation of arrival times across the array.

As an example, if there is a Gaussian distribution of timing with a standard deviation of 0.1 msec timing between elements of an array, then there would be 12 dB of attenuation of the seismic signal at 2 kHz. This would be the case for a 15 cm difference in vertical position of the receivers in an array. Since these streamers are typically towed at a shallow depth below the sea surface, the impact of waves is likely to cause this level of difference over a short length of a streamer. This is a significant issue when the high-resolution objective of these surveys may include data up to and beyond 5 kHz as shown in FIG. 2. The same issue exists at the source position if the source is not a single point source, with a single element.

There exists a need for improved apparatus and methods for high resolution sub-bottom marine seismic surveys.

### SUMMARY

One aspect of the present disclosure is a method for marine seismic surveying. A method according to this aspect includes deploying a plurality of seismic sensors onto the bottom of a body of water. The deploying includes moving to the bottom of the body of water at least one sensor frame having seismic sensors disposed therein in fixed positions. A vessel is moved on a surface of the body of water proximate a location of the plurality of seismic sensors on the bottom of the body of water. The vessel has mounted to it a plurality of seismic energy sources at fixed positions in a direction transverse to a direction of motion of the vessel so as to be suspended from the vessel into the body of water. At selected times or positions, the plurality of seismic energy sources is actuated. Seismic energy is detected at the plurality of seismic sensors in response to energy emitted by the seismic energy sources interacting with formations below the bottom of the body of water.

In some implementations, each of the plurality of seismic energy sources is actuated at a different time than any other of the plurality of seismic energy sources.

In some implementations the seismic sensors comprise a collocated pressure responsive sensor and particle motion responsive sensor.

In some implementations, the seismic energy sources comprise one or more of air guns, sparkers or boomers.

Some implementations further comprise deploying in the body of water a plurality of sensor frames each having a plurality of seismic sensors disposed therein at fixed positions.

In some implementations, the seismic sensors in each of the plurality of frames comprise a collocated pressure responsive sensor and particle motion responsive sensor.

Some implementations further comprise processing the detected seismic energy from each of the plurality of seismic sensors to detect seismic energy reflected from the formations and subsequently reflected from the surface of the body of water.

A seismic sensor deployment apparatus according to another aspect of the present disclosure includes a center disk and a plurality of arms each pivotally coupled to the center disk at one longitudinal end of each arm. An opposed longitudinal end of each arm comprises an opening for mounting a seismic sensor therein.

In some implementations, the center disk comprises an opening for mounting a seismic sensor therein.

Some implementations further comprise a deployment cable extending at one end from the center disk, the deployment cable having a float disposed at another end.

In some implementations, the deployment cable comprises a remotely operable latch disposed at a selected position along a length of the deployment cable intermediate the float and the center disk, a portion of the deployment cable coupled to a bottom part of the latch having a buoyancy device coupled thereto.

In some implementations, the remotely operable latch is disposed at a location below an expected depth of surface vessels traversing a body of water into which the apparatus is deployed.

In some implementations, the plurality of arms are equally circumferentially spaced around the center disk.

In some implementations, a number of the arms comprises six.

A seismic sensor array for deployment on a bottom of a body of water according to another aspect of the present disclosure includes a sensor frame comprising a center disk and a plurality of arms each pivotally coupled to the center disk at one longitudinal end of each arm, an opposed longitudinal end of each arm comprising an opening for mounting a seismic sensor therein. A seismic sensor is disposed in each of the openings.

In some implementations, the center disk comprises an opening for mounting a seismic sensor therein and a seismic sensor disposed in the opening in the center disk.

Some implementations further comprise a deployment cable extending at one end from the center disk, the deployment cable having a float disposed at another end.

In some implementations, the deployment cable comprises a remotely operable latch disposed at a selected position along a length of the deployment cable intermediate the float and the center disk, a portion of the deployment cable coupled to a bottom part of the latch having a buoyancy device coupled thereto.

In some implementations, the remotely operable latch is disposed at a location below an expected depth of surface vessels traversing a body of water into which the apparatus is deployed.

In some implementations, the plurality of arms are equally circumferentially spaced around the center disk.

In some implementations, a number of the arms comprises six.

In some implementations, the seismic sensors each comprises a collocated pressure responsive sensor and particle motion responsive sensor.

In some implementations, the arms are traversed with ropes to attach additional seismic sensors.

Other aspects and possible advantages will be apparent from the description and claims that follow.

### BRIEF DESCRIPTION OF THE DRAWINGS

FIG. 1 shows a configuration of a towed streamer seismic survey apparatus.

FIG. 2 shows a graph of signal attenuation with respect to frequency for a hydrophone array used in the apparatus of FIG. 1.

FIG. 3A shows a vertical view of seismic sensors deployed using one example implementation of a sensor frame according to the present disclosure.

FIG. 3B shows a plan view of the sensor deployed using the frame of FIG. 3A.

FIG. 4A shows a vertical view of seismic sensors deployed using one example implementation of a sensor frame according to the present disclosure.

FIG. 4B shows a plan view of the sensor deployed using the frame of FIG. 4A.

FIG. 5 shows a float and disconnect apparatus used in connection with an apparatus as in FIG. 3A or 3B.

FIG. 6 shows a more detailed view of the sensor frame of FIG. 4B.

FIG. 7 shows an example of a collapsible arm for a frame according to the present disclosure.

FIG. 8 shows an example deployment of multiple sensor frames as in FIG. 6 in a selected pattern on the water bottom.

FIG. 9A shows an example implementation of a frame in plan view.

FIG. 9B shows the frame of FIG. 9A in oblique view.

FIG. 9C shows one of the arms in the frame of FIG. 9A in more detail.

FIG. 10 shows an example arrangement of towed seismic sources according to the present disclosure.

FIG. 11 shows an example of source actuation (shot) points using the arrangement of FIG. 10.

FIG. 12A shows a diagram of ray paths for seismic surveying using upgoing energy detected at the sensors.

FIG. 12B shows an enlarged view of FIG. 12 to illustrate limitations of using upgoing seismic energy for imaging shallow, thin sub bottom sediment layers.

FIG. 13A shows a diagram of ray paths for seismic surveying using downgoing energy reflected from the water surface to image sub bottom layers.

FIG. 13B shows an enlarged view of FIG. 13A.

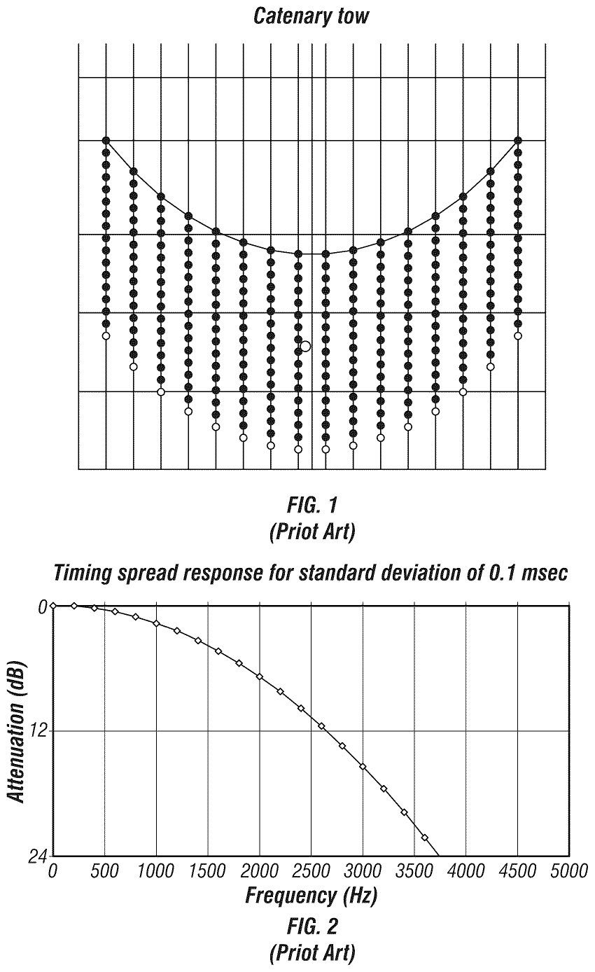

### DETAILED DESCRIPTION

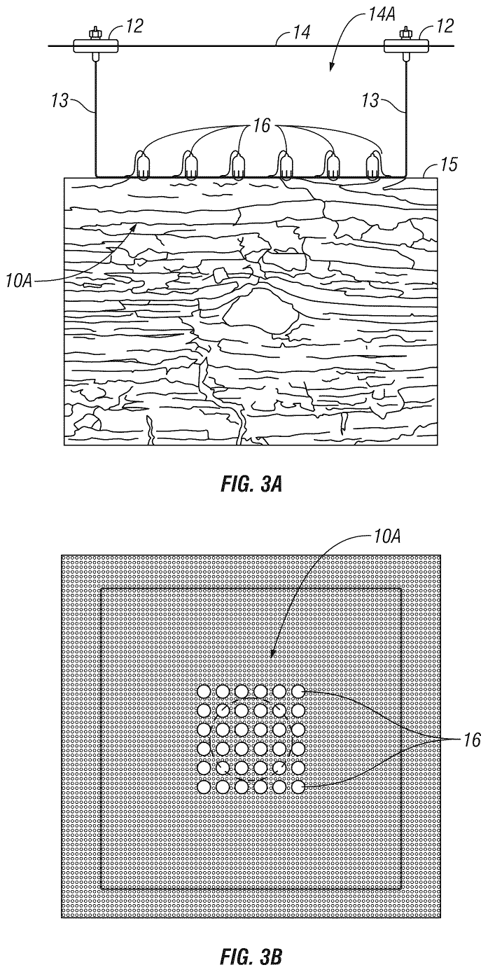

An example arrangement of seismic sensors and a seismic sensor deployment frame (“frame” for convenience) in accordance with the present disclosure are shown in a vertical section view in FIG. 3A. In order to maintain stability and accuracy of positions of seismic sensors 16 during deployment, the seismic sensors 16 may be disposed in the frame 10A, and the frame 10A may be lowered to the bottom 15 of a body of water 14A, the surface of which body is shown at 14. The frame 10A may be lowered into the water by one or more cables 13. The surface ends of the one or more cables 13 may be connected to a respective float or buoy 12 for location and in some implementations power and signal communication. A plan view of the arrangement of seismic sensors 16 in the frame 10A is shown in FIG. 3B. The frame 10A may dispose the seismic sensors 16 in a square or rectangular pattern as shown. The manner of securing the seismic sensors in the frame 10A and the particular structure of the frame 10A are matters of discretion for the designer and are not intended to limit the scope of the present disclosure.

In some implementations, the frame 10A may be deployed on the water bottom 15 by a remotely operated vehicle (ROV) and the cables 13 subsequently deployed such as by release from the frame 10A and allowing the floats or buoys 12 to rise to the water surface 14.

It is contemplated that the seismic sensors 16 may comprise four component (4C) sensing elements, that is, the sensing elements (not shown separately) may comprise a hydrophone or other pressure responsive sensor and three particle motion responsive sensors such as geophones or accelerometers arranged to have sensitive axes along different directions (e.g., orthogonal with at least one direction being vertical). For purposes of seismic imaging using such seismic sensors, the pressure and particle motion sensing elements are deemed to be at the same geodetic location, i.e., collocated. The type of seismic sensors and sensing elements are not limitations on the scope of the present disclosure, however, in the case of particle motion responsive seismic sensors, it is contemplated that the seismic sensors 16 will be mounted in the frame 10A such that the seismic sensors 16 make good contact with the water bottom 15. The frame 10A may be particularly weighted, e.g., may comprise dense material weights (not shown) such as may be made from lead to assist in coupling the seismic sensors 16 to the water bottom 15. In some implementations, the seismic sensors 16 may be individual nodes, in which sensing elements, signal processing, signal recording and power supply devices may all be disposed in a single housing. In some implementations the seismic sensors 16 may comprise only the sensing elements; signals may be conducted along the cable(s) 13 to signal processing and recording devices (not shown separately) disposed in one of the buoys 12 or elsewhere. The type of seismic sensor (e.g., self-contained node or cable connected) and the location of any signal processing and/or recording equipment are not intended to limit the scope of the present disclosure.

In the present example implementation, the pressure responsive sensing element may comprise a single hydrophone because the seismic sensors 16 are not exposed to water flow related noise such as would affect hydrophones in a towed streamer. Single hydrophones may avoid loss of resolution resulting from a sensor array having non-zero effective length.

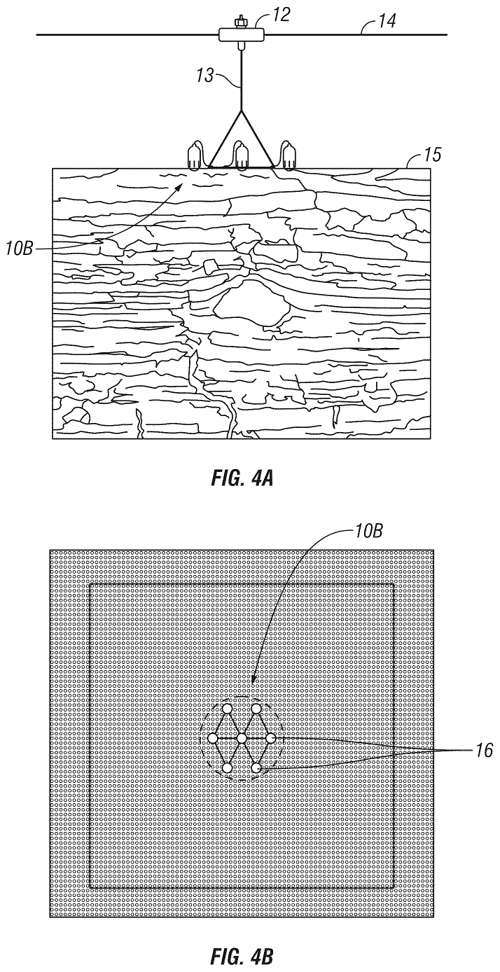

Another example implementation of a frame is shown in vertical section view in FIG. 4A at 10B, and in plan view in FIG. 4B. The example implementation of the frame 10B may have seismic sensors 16 disposed in a generally hexagonal pattern with one seismic sensor 16 located in the geometric center of the hexagonal pattern, and one seismic sensor disposed at the end of each of a plurality of radially extending arms. As will be further explained below, the example implementation in FIGS. 4A and 4B may provide advantages such as a smaller storage “footprint” when the frame 10B and associated seismic sensors 16 are not deployed, and a smaller cross-sectional area when the frame 10B is lowered into the body of water 14A, thereby facilitating movement through the water 14A to the water bottom 15 during deployment.

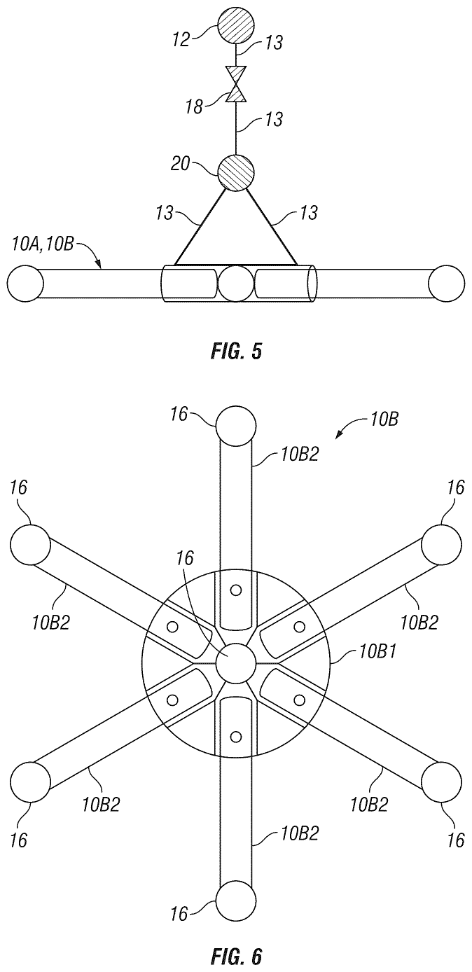

It will be appreciated that extended deployment of the frame with one or more cables extending to the water surface 14 may present an obstacle or hazard to ship navigation. FIG. 5 shows an example implementation that may be helpful to avoid such situations. The one or more cables 13 may comprise, along the length thereof, an ultrasonic location transceiver 20, and a remotely (e.g., acoustic or by ROV) operable latch 18 which may be actuated to release the segment of the cable 13 attached to the buoy 12, thus leaving attached to the frame 10A, 10B only the part of the cable 13 up to the transceiver 20. In this way, no obstructions to surface vessel movement are presented by the cable. In the example implementation of FIG. 5, the portion of the cable 13 disposed below the transceiver 20 may be made in the form of a loop as shown or have a loop in order to facilitate retrieval of the frame 10B and sensors 16 with a grapple or similar device deployed from a surface vessel or ROV.

FIG. 6 shows the example implementation of the frame 10B of FIGS. 4A and 4B in more detail. The frame 10B may comprise a center disk shaped portion 10B1 (disk) from which may extend radially outwardly a plurality (in the present example six) of sensor mounting arms 10B2. One or more seismic sensors as explained above may be attached to the sensor mounting arms 10B1 as shown.

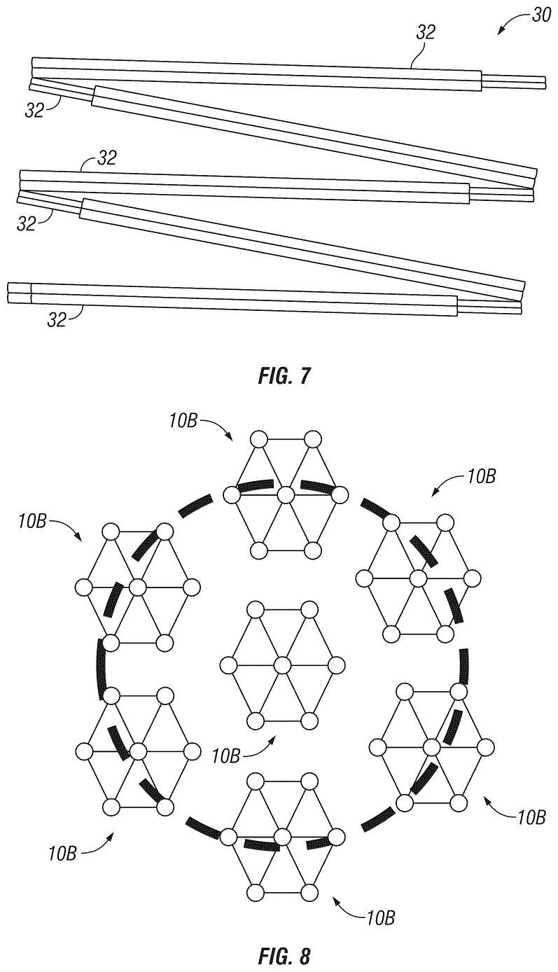

FIG. 7 shows an example of a collapsible deployment structure 30. The structure 30 may comprise a plurality of hingedly interconnected structure arms 32, which may unfold when the structure 30 is deployed on the water bottom (15 in FIG. 3A). A plurality of frames such as shown in FIG. 6 may be attached to the structure 30 such that when the foregoing are deployed to the water bottom (15 in FIG. 3A), the frames 10B will be deployed in a pattern such as shown in FIG. 8, wherein six frames 10B are disposed in a symmetric pattern about a centrally located frame 10B. Each of the foregoing frames 10B may be substantially as explained with reference to FIG. 6. After deployment of one or more frames 10B having sensors therein to the water bottom (15 in FIG. 3A), locations of the sensors 16 may be obtained using techniques for water bottom sensor location known in the art, e.g., acoustic travel time along multiple propagation paths. See, for example, U.S. Pat. No. 4,641,287 issued to Neely. Because the locations of each sensor with respect to each other in one of the frames is known, uncertainty in position of the sensors using such known techniques may be improved; knowledge of the sensor positions within the or each frame may be used to constrain results of location determination using such known techniques

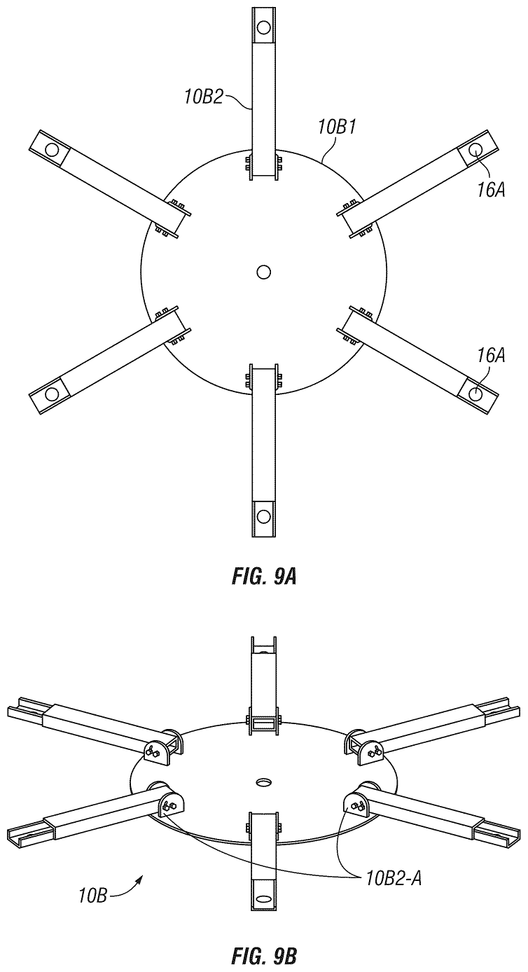

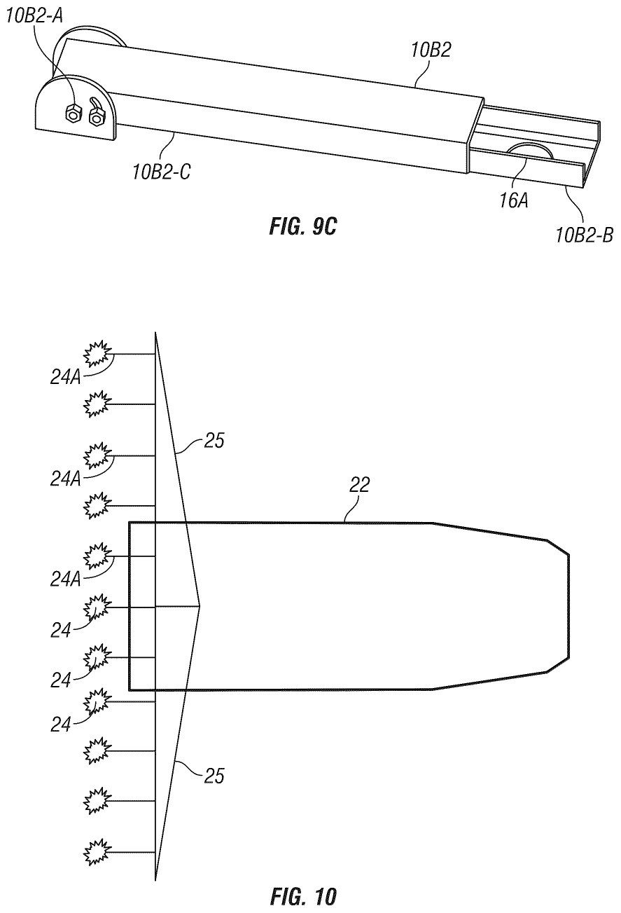

FIGS. 9A, 9B and 9C show various views of the example implementation of the frame 10B explained with reference to FIGS. 4A and 4B. The frame 10B as explained above may comprise a central disk 10B1 to which may be hingedly attached a plurality (in this case six) sensor mounting arms 10B2. Example dimensions, not to be construed as a limitation on the scope of this disclosure, shown in FIG. 9A comprise a center to center spacing from a sensor mounting position 16A at the end of each sensor mounting arm 10B2 to a center of the disk 10B1 of 1.0 meter. An inter-arm spacing at the sensor mounting points between adjacent arms 10B2 may be 1.0 meter. A seismic sensor (not shown in FIGS. 9A through 9C) may be mounted where shown, at 16A, at the end of each sensor mounting arm 10B2 and in the center of the disk 10B1. FIG. 9B shows an oblique view of the frame 10B to illustrate hinged coupling (e.g., by hinges 10B2-A) of the sensor mounting arms 10B2 to the disk 10B1.

FIG. 9C shows an example implementation of one of the sensor mounting arms 10B2 in more detail. The sensor mounting arm 10B2 may comprise a channel or similar structure 10B2-B nested within the part 10B2-C of the sensor mounting arm 10B2 that is coupled to the disk (10B1 in FIG. 9B) by a hinge or pivot 10B2-A. The nested channel 10B2-B may be extended or retracted to change an effective length of the sensor mounting arm 10B2 so that different sensor spacings may be accommodated.

In some implementations, the arms are traversed with ropes to attach additional seismic sensors.

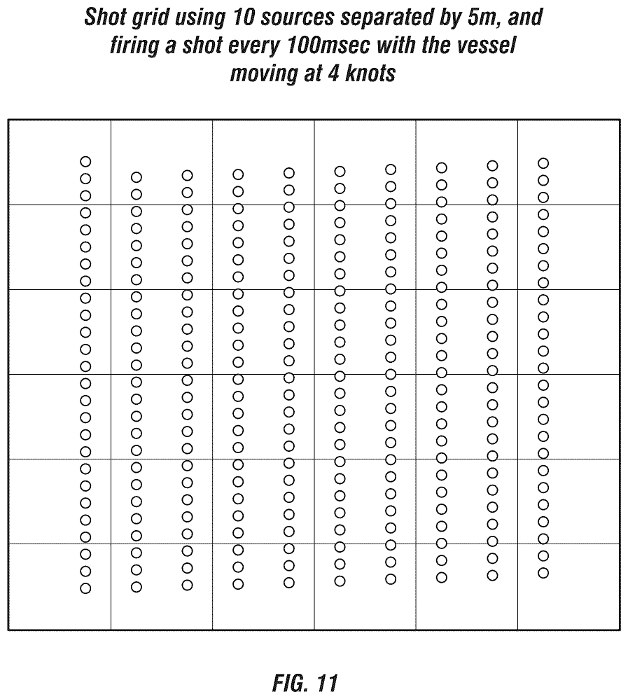

FIG. 10 shows an example implementation of an arrangement for seismic energy sources in accordance with the present disclosure. A vessel 22, which may be a seismic survey vessel or seismic source vessel has equipment thereon to tow a plurality of seismic energy sources 24 (“sources”) in the water (14A in FIG. 3A). The sources 24 may be arranged in a line array, such as by being deployed from a crane or boom 25 extending from the vessel 22 in a direction transverse to the direction of motion of the vessel 22. In this way, variations in actual position of the sources 24 with respect to the vessel position may be minimized. Thus, determination of the vessel position, such as by geodetic position signal receiver e.g., (GPS or GNSS) may be used to precisely locate the geodetic position of each one of the sources 24 at any actuation time. The sources 24 shown in FIG. 10 may be, for example and without limitation, sparkers, boomers and air guns. The energy emitted from the sources 24 preferably has substantial amplitude in the frequency range up to 2 kHz. The individual sources 24 may be attached to the crane or boom 25 using cables 24A or the like. By suspending the crane or boom 25 only a short elevation above the water surface (14 in FIG. 3A), the cables 24A may be kept to as small a length as practical, so as to minimize variations in source position relative to the vessel 22, while the sources 24 are suspended in the body of water. Not shown in FIG. 10, but as may be useful, the vessel 22 may comprise navigation and source actuation control equipment of types known in the art for actuating the sources 24 at selected times or at selected geodetic positions. Navigation equipment (not shown separately) may comprise a geodetic position signal receiver such as a GPS or GNSS satellite signal receiver in order to have a measurement of the geodetic position of the vessel 22 at any time. Thus by determining the vessel position at any time, and with knowledge of the relative position of each source 24 with respect to the location of the geodetic position signal receiver onboard the vessel 22, the geodetic position of each source 24 may be determined at any moment in time with precision reduced only by an amount of movement of the sources 24 about the cables 24A with reference to the vessel 22. By minimizing the length of the cables 24A, uncertainty of the positions of the sources 24 may be correspondingly minimized.

FIG. 11 shows a possible source actuation point (shot point) pattern obtainable with the source and vessel arrangement shown in FIG. 10. As an example, if the volume of the subsurface to be imaged is disposed within 100 meters (m) of the water bottom (15 in FIG. 3A), and the seismic velocity (e.g., compressional) in this volume is on average 2000 m/sec, the time of interest of detecting relevant seismic energy would be 2×100/2000 seconds, or about 100 msec. As a practical matter, then, one of the sources (24 in FIG. 10) could be actuated every 100 msec while avoiding detection of seismic energy originating from any of the outer sources (24 in FIG. 10). Ten such sources could be actuated every second; if the vessel is moving along the water surface at 2 m/second (˜4 knots) then the vessel would move 2 m in the time it takes to fire all ten sources. For a grid of 10 sources separated laterally from each other as shown in FIG. 10 by 5 m, each source could therefore be actuated 25 times, to obtain 250 shots in a grid of shot points over a 25×50 m survey area.

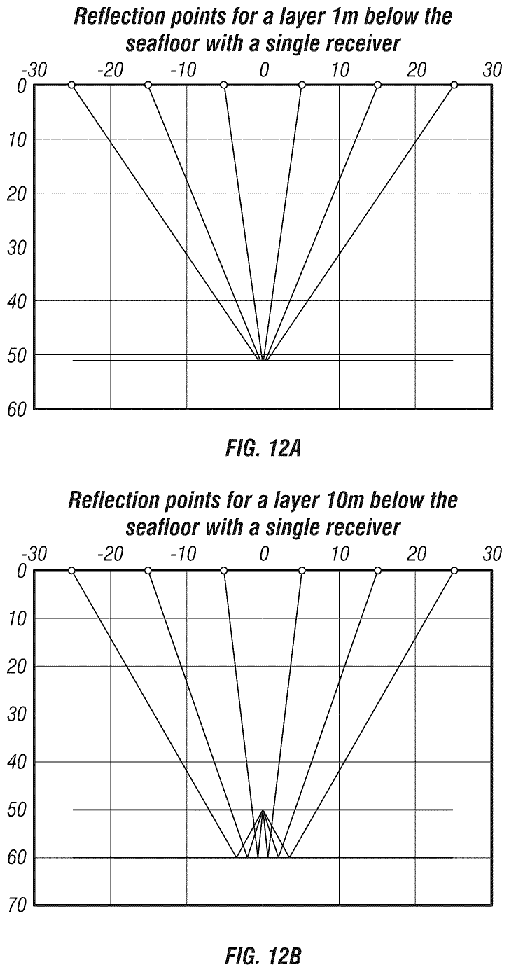

The survey obtained using sources and sensors deployed as explained herein will provide a set of seismic signal recordings from each sensor (traces) equal in number to twice the product of the number of source actuations (shots) and the number of sensors (assuming that there is a hydrophone and a single geophone at each sensor location; multiple component geophones will correspondingly increase the number of traces). However, there is an intrinsic problem when seismic sensors are located at or near the water bottom in the case of imaging the layers immediately below the water bottom. Typical seismic imaging uses portions of the seismic signals detected by each sensor that propagates downwardly from the source, and is reflected up from the layers of interest to the sensors. This is referred to as the “up-going” wavefield. When the sensors are close in depth to the layers of interest, the area of the subsurface which is examined is localized around the sensors. In the limit, the area is the vertical position of the sensors because there is only upgoing energy immediately below each sensor. This is illustrated in FIGS. 12A and 12B, which is an expanded view of FIG. 12A.

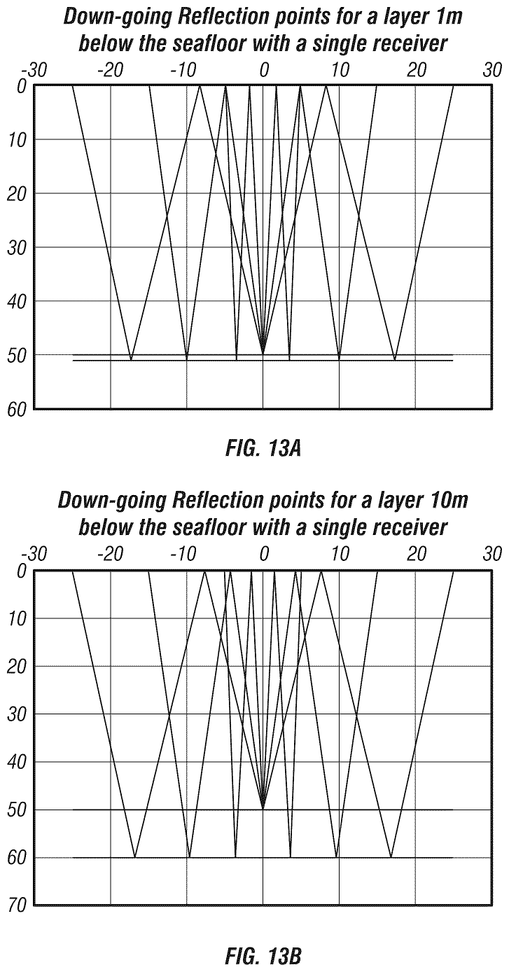

To address the limitation created by depth proximity of the formations to be imaged with reference to the seismic sensors (that is, the formations are shallow), in some implementations, it is possible to obtain seismic signals that represent downgoing seismic energy, wherein the upgoing energy that has been reflected from layers below the water bottom is reflected from the water surface and is detected by the seismic sensors (16 in FIG. 3A). If the seismic sensors each comprise a hydrophone and a geophone (preferably oriented to detected along a vertical direction) then it is possible to separate the upgoing and down-going seismic energy (wavefields). The resulting area imaged with the down-going wavefield is much larger. This is illustrated in FIGS. 13A and 13B, which correspond to FIGS. 12A and 12B, but show detecting downgoing seismic energy, that is after reflection from the water surface. Note that when imaging uses the downgoing wavefield, the area of the subsurface image extends almost to the edge of the shot area for even the shallowest layers in the subsurface. Furthermore, Full Waveform Imaging (FWI) data processing is able to utilize all the multiples (energy which has travelled upward to the water surface and down after water surface reflection more than one time), to create images of the reflections, and can create images at the shallowest layer, including the water bottom itself.

In light of the principles and example implementations described and illustrated herein, it will be recognized that the example implementations can be modified in arrangement and detail without departing from such principles. The foregoing discussion has focused on specific implementations, but other configurations are also contemplated. In particular, even though expressions such as in “an implementation,” or the like are used herein, these phrases are meant to generally reference implementation possibilities, and are not intended to limit the disclosure to particular implementation configurations. As used herein, these terms may reference the same or different implementations that are combinable into other implementations. As a rule, any implementation referenced herein is freely combinable with any one or more of the other implementations referenced herein, and any number of features of different implementations are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for marine seismic surveying, comprising:
deploying a plurality of seismic sensors onto the bottom of a body of water, the deploying comprising moving to the bottom of the body of water at least one sensor frame having seismic sensors disposed therein in fixed positions when the at least one sensor frame is on the bottom of the body of water;
moving a vessel on a surface of the body of water proximate a location of the plurality of seismic sensors on the bottom of the body of water, the vessel having mounted thereto a plurality of seismic energy sources at fixed positions in a direction transverse to a direction of motion of the vessel so as to be suspended from the vessel into the body of water;
at selected times or positions, actuating the plurality of seismic energy sources; and
detecting seismic energy at the plurality of seismic sensors in response to energy emitted by the seismic energy sources interacting with formations below the bottom of the body of water.

2. The method of claim 1 wherein the each of the plurality of seismic energy sources is actuated at a different time than any other of the plurality of seismic energy sources.

3. The method of claim 1 wherein the seismic sensors each comprises a collocated pressure responsive sensor and particle motion responsive sensor.

4. The method of claim 1 wherein the seismic energy sources comprise one or more of air guns, sparkers or boomers.

5. The method of claim 1 further comprising deploying in the body of water a plurality of sensor frames each having a plurality of seismic sensors disposed therein at fixed positions.

6. The method of claim 5 wherein the seismic sensors in each of the plurality of frames comprise a collocated pressure responsive sensor and particle motion responsive sensor.

7. The method of claim 1 further comprising processing the detected seismic energy from each of the plurality of seismic sensors to detect seismic energy reflected from the formations and subsequently reflected from the surface of the body of water.

8. A seismic sensor deployment apparatus, comprising:
a center disk; and
a plurality of arms each pivotally coupled to the center disk at one longitudinal end of each arm, an opposed longitudinal end of each arm comprising an opening for mounting a seismic sensor therein.

9. The apparatus of claim 8, wherein the center disk comprises an opening for mounting a seismic sensor therein.

10. The apparatus of claim 8, further comprising a deployment cable extending at one end from the center disk, the deployment cable having a float disposed at another end.

11. The apparatus of claim 10 wherein the deployment cable comprises a remotely operable latch disposed at a selected position along a length of the deployment cable intermediate the float and the center disk, a portion of the deployment cable coupled to a bottom part of the latch having a buoyancy device coupled thereto.

12. The apparatus of claim 11 wherein the remotely operable latch is disposed at a location below an expected depth of surface vessels traversing a body of water into which the apparatus is deployed.

13. The apparatus of claim 8 wherein the plurality of arms are equally circumferentially spaced around the center disk.

14. The apparatus of claim 8 wherein a number of the arms comprises six.

15. The apparatus of claim 8 wherein each of the arms is longitudinally extendable.

16. The apparatus of claim 8 where the detectors are mounted between the arms of the frame and attached by rope or cable.

17. A seismic sensor array for deployment on a bottom of a body of water, comprising:
a sensor frame comprising a center disk and a plurality of arms each pivotally coupled to the center disk at one longitudinal end of each arm, an opposed longitudinal end of each arm comprising an opening for mounting a seismic sensor therein; and
a seismic sensor disposed in each of the openings.

18. The array of claim 17 wherein the center disk comprises an opening for mounting a seismic sensor therein and a seismic sensor disposed in the opening in the center disk.

19. The array of claim 17, further comprising a deployment cable extending at one end from the center disk, the deployment cable having a float disposed at another end.

20. The array of claim 19 wherein the deployment cable comprises a remotely operable latch disposed at a selected position along a length of the deployment cable intermediate the float and the center disk, a portion of the deployment cable coupled to a bottom part of the latch having a buoyancy device coupled thereto.

21. The array of claim 20 wherein the remotely operable latch is disposed at a location below an expected depth of surface vessels traversing a body of water into which the apparatus is deployed.

22. The array of claim 17 wherein the plurality of arms are equally circumferentially spaced around the center disk.

23. The array of claim 17 wherein a number of the arms comprises six.

24. The array of claim 17 wherein the seismic sensors each comprises a collocated pressure responsive sensor and particle motion responsive sensor.

25. The array of claim 17 wherein each of the arms is longitudinally extendable.

26. The method of claim 17 where the detectors are mounted between the arms of the frame and attached by rope or cable.
